(19) United States
(12) Patent Application Publication
(10) Pub. No.: US 2006/0100802 A1
(43) Pub. Date: May 11, 2006

(54) Method for evaluating diagnosis function of a variable valve mechanism and apparatus for diagnosing a variable valve mechanism

(75) Inventors: Ryo Miyakoshi, Isesaki-shi (JP); Kenichi Machida, Isesaki-shi (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 11/267,147

(22) Filed: Nov. 7, 2005

(30) Foreign Application Priority Data
Nov. 9, 2004 (JP) 2004-325034

(51) Int. Cl. G06F 11/30

(52) U.S. Cl. 702/79; 702/183

(57) ABSTRACT

Gains of a feedback control of a variable valve mechanism are varied so that a response delay occurs. As a result that a transient response is diagnosed under this state, in the case where the occurrence of response delay is not judged, it is judged that a response diagnosis function is abnormal.

### BACKGROUND OF THE INVENTION

1. Field of the Invention

The present invention relates to a method for evaluating a function of diagnosing a transient response of a variable valve mechanism which operates to vary an operating characteristic of an engine valve and an apparatus for executing the same method.

2. Description of the Related Art

Japanese Unexamined Patent Publication No. 2000-073794 discloses a technology for computing a deviation between a target value of an operating characteristic of an engine valve and an actual value thereof, and for diagnosing an occurrence of a response delay in a variable valve mechanism in the case where such a state that the deviation exceeds a judgment value continues for a predetermined time of period or more.

If the above diagnosis processing normally functions, it is possible to warn an occurrence of an abnormality in which the response delay becomes larger. However, if the diagnosis processing does not normally function, an engine is operated in a state where a large response delay occurs, resulting in deteriorating the engine performance at the time of accelerating operation thereof which particularly accompanies the switching of a target operating characteristic of the engine valve.

### SUMMARY OF THE INVENTION

It is therefore an object of the present invention to evaluate whether or not the diagnosis of a response delay normally functions in a variable valve mechanism which operates to vary an operating characteristic of an engine valve, to thereby improve the reliability of the response delay diagnosis.

In order to achieve the above object, in accordance with the present invention, a transient response is diagnosed in a state where the transient response of a variable valve mechanism is forcibly degraded, and a diagnosis function is evaluated based on this diagnosis result.

The other objects and features of the invention will become understood from the following description with reference to the accompanying drawings.

### BRIEF DESCRIPTION OF THE DRAWINGS

FIG. 1 is a cross-sectional view showing a variable valve timing apparatus according to an embodiment of the present invention.

FIG. 2 is a cross-sectional view taken along the line of B-B of FIG. 1.

FIG. 3 is an exploded perspective view of the variable valve timing apparatus.

FIG. 4 is a cross-sectional view showing a solenoid type switching valve in the variable valve timing apparatus.

FIG. 5 is a cross-sectional view showing the solenoid type switching valve in the variable valve timing apparatus.

FIG. 6 is a cross-sectional view showing the solenoid type switching valve in the variable valve timing apparatus.

FIG. 7 is a flowchart showing the evaluation processing of diagnosis function according to the present invention.

FIG. 8 is a flowchart showing the switch processing of feedback gains in step S2 of FIG. 7.

FIG. 9 is a block diagram showing a feedback control of the variable valve timing apparatus in the embodiment.

FIG. 10 is a time chart showing a response change accompanied by the switching of the feedback gains.

FIG. 11 is a flowchart showing the response diagnosis processing in step S4 of FIG. 7.

FIG. 12 is a time chart showing an embodiment for limiting a range of manipulated variable in the variable valve timing apparatus.

FIG. 13 is a graphical view showing a correlation between the manipulated variable in the variable valve timing apparatus and an oil flow amount.

FIG. 14 is a flowchart showing the evaluation processing of diagnosis function according to another embodiment of the present invention.

FIG. 15 is a flowchart showing the limitation processing of a manipulated variable in step S2A of FIG. 14.

### PREFERRED EMBODIMENT

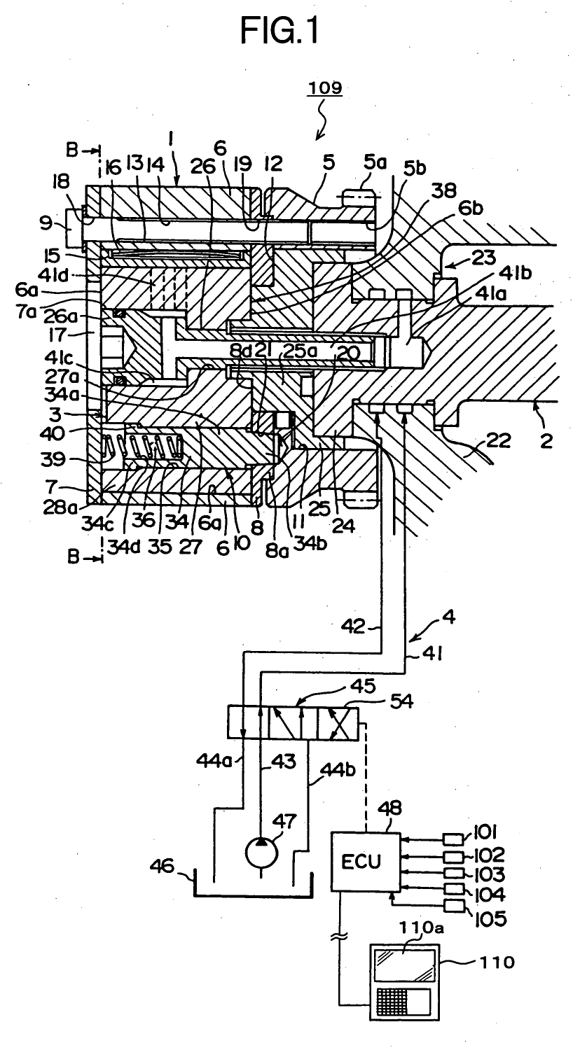

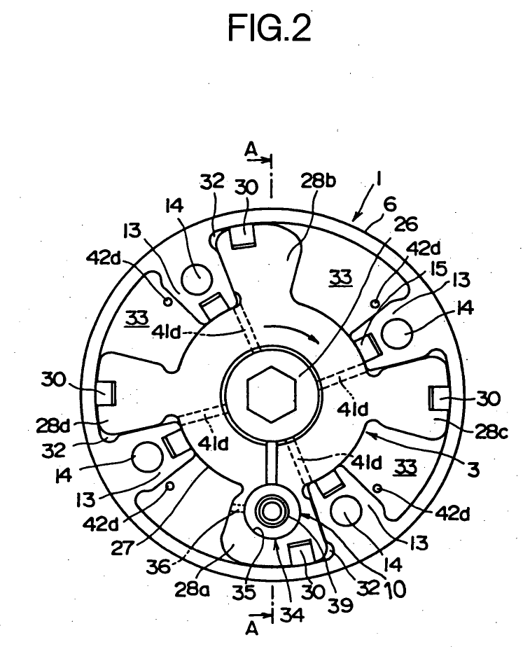

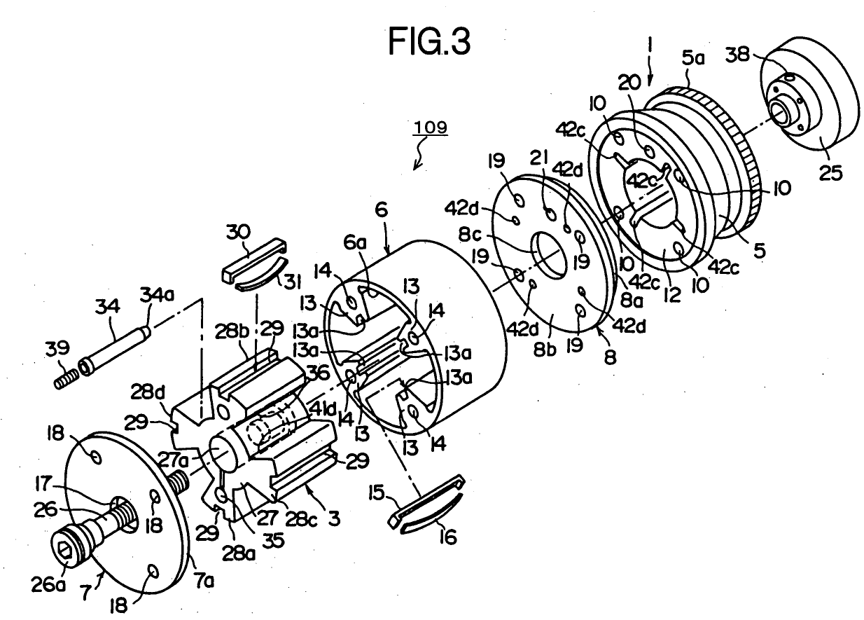

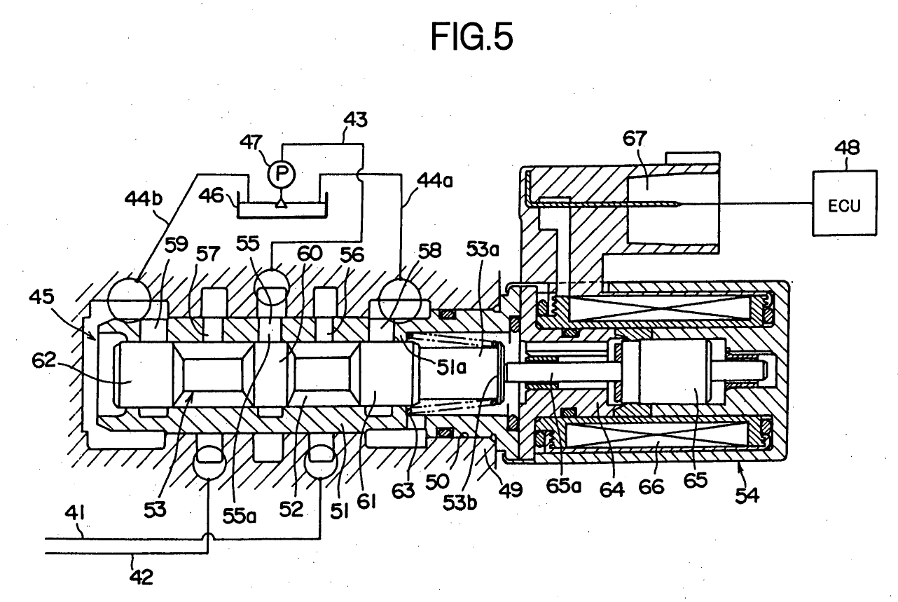

FIG. 1 through FIG. 6 each shows a variable valve timing apparatus 109 as a variable valve mechanism in an embodiment, which is applied to the intake valve in a vehicle internal combustion engine.

Variable valve timing apparatus 109 shown in the figures includes: a cam sprocket 1 which is rotatably driven by a crankshaft (not shown in the figures) of the engine via a timing chain; a camshaft 2 disposed to be relatively rotatable with respect to cam sprocket 1; a rotation member 3 secured to an end portion of camshaft 2 to be rotatably housed inside cam sprocket 1; a hydraulic circuit 4 which operates to relatively rotate rotation member 3 with respect to cam sprocket 1; and a lock mechanism 10 which selectively locks a relative rotation position between cam sprocket 1 and rotation member 3 at predetermined positions.

Cam sprocket 1 includes: a rotation member 5 having, on an outer periphery thereof, teeth portion 5a with which the timing chain is engaged; a housing 6 located ahead of rotation member 5, for rotatably housing rotation member 3; a front cover 7 for closing a front end opening of housing 6; and a rear cover 8 arranged between housing 6 and rotation member 5, for closing a rear end portion of housing 6.

Rotation member 5, housing 6 and front cover 7, and rear cover 8, are integrally coupled by means of four threaded bolts 9 from the axial direction.

Rotation member 5 presents a substantially annular shape, and has four internally threaded through-holes 5b, into which respective small diameter threaded bolts 9 are screwed, formed in rotation member 5 in the front-and-aft direction at equidistantly spaced positions at about 90° in the circumferential direction. Further, a fitting hole 11, in which a later-described sleeve 25 is fitted, is formed through rotation member 5 at an inner center position thereof.

Furthermore, a fitting groove 12 of circular disc shape, in which rear cover 8 is fitted, is formed in a front end face of rotation member 5.

Housing 6 presents a cylindrical shape formed with both front and rear ends open and is provided with four partition portions 13 provided to internally protrude at positions on an inner peripheral face at 90° in the circumferential direction.

Four partition portions 13 each presents a trapezoidal shape in transverse section and is provided along the axial direction of housing 6, so that both edges of each partition portion 13 are in planar with both edges of housing 6. Also, four bolt insertion holes 14, into which threaded bolts 9 are inserted, are respectively bored through four partition portions 13 on the base end sides thereof to the axial direction.

Moreover, a C-shaped sealing member 15 and a leaf spring 16 for inwardly pressing sealing member 15 are fittingly retained in a retaining groove 13a notched at a center position on an inner end face of each partition portion 13 along the axial direction.

A central bolt insertion hole 17 is bored through front cover 7, and also, four bolt holes 18 are bored through front cover 7 at positions corresponding to respective bolt insertion holes 14 of housing 6.

Rear cover 8 includes a circular disc portion 8a which is fittingly retained in fitting groove 12 of rotation member 5, on a rear end face thereof. Also, a fitting hole 8c in which a small diameter annular portion 25a of sleeve 25 is fitted is formed through rear cover 8 at a center position thereof. Further, four bolt holes 19 are bored at positions corresponding to respective bolt insertion holes 14.

Camshaft 2 is rotatably supported on an upper end portion of a cylinder head 22 via a camshaft bearing 23. At a predetermined position on an outer peripheral face of camshaft 2, a cam (not shown in the figures) which operates to open an intake valve via a valve lifter is integrally disposed, and also, on a front end portion of camshaft 2, a flange portion 24 is integrally disposed.

Rotation member 3 is securely fixed to the front end portion of camshaft 2 by means of a fixing bolt 26 which is inserted from the axial direction via sleeve 25 whose front and rear portions are fitted in flange portion 24 and fitting hole 11, and includes: an annular base portion 27 having a bolt insertion hole 27a into which fixing bolt 26 is inserted at a center position thereof; and four vanes 28a, 28b, 28c, and 28d provided integrally on an outer peripheral face of base portion 27 to be spaced apart from one another by 90° in the circumferential direction.

First through fourth vanes 28a to 28d present respectively cross-sections of approximate trapezoidal shapes. The vanes are disposed in recess portions between each partition portion 13 so as to form spaces in the recess portions to the front and rear in the rotation direction. Thus, advance angle side hydraulic chambers 32 and retarded angle side hydraulic chamber 33 are formed respectively between both sides of respective vanes 28a to 28d and both side faces of respective partition portions 13.

A C-shaped sealing member 30 which abuts an inner peripheral face 6a of housing 6 and a leaf spring 31 for outwardly pressing sealing member 30 are fittingly retained in a retaining groove 29 which is notched in the axial direction at the center of an outer peripheral face of each of vanes 28a to 28d.

Lock mechanism 10 includes: an engaging groove 20 formed at a predetermined position on the outer periphery side of fitting groove 12 of rotation member 5; an engaging hole 21 having a tapered inner peripheral face which is formed through rear cover 8 at a predetermined position thereof; a sliding hole 35 formed through along the inner axial direction at a substantially center position of one vane 28 corresponding to engagement hole 21; a lock pin 34 slidably disposed in sliding hole 35 of the one vane 28; a coil spring 39 being a spring member attached on the rear end side of lock pin 34; and a pressure receiving chamber 40 formed between lock pin 34 and sliding hole 35.

Lock pin 34 includes: a center side body 34a; an engaging portion 34b formed in tapered cone shape on the tip end side of body 34a; and a stopper portion 34c of stepped large diameter formed on the rear end side of body 34a.

Lock pin 34 is urged toward engagement hole 21 by a spring force of coil spring 39 elastically interposed between a bottom face of an inner recess groove 34d of stopper portion 34c and an inner end face of front cover 7, and is also slidable to be retracted from engagement hole 21 by a hydraulic pressure in pressure receiving chamber 40 formed between an outer peripheral face between body 34a and stopper portion 34c, and an inner peripheral face of sliding hole 35.

Pressure receiving chamber 40 communicates with each retarded angle side hydraulic chamber 33 via a passing hole 36 formed on a side portion of the vane 28.

Further, engaging portion 34b of lock pin 34 is engaged in engagement hole 21 at a rotated position of rotation member 3 to the maximum retarded angle side.

Hydraulic circuit 4 has a dual system oil pressure passage, namely a first oil pressure passage 41 for supplying and discharging oil pressure to advance angle side hydraulic chambers 32, and a second oil pressure passage 42 for supplying and discharging oil pressure to retarded angle side hydraulic chambers 33. To these two oil pressure passages 41 and 42 are connected a supply passage 43 and a drain passage 44, respectively, via an electromagnetic type or solenoid type switching valve 45 for switching the passages.

An oil pump 47 for pumping oil in an oil pan 46 is provided in supply passage 43, and the downstream ends of drain passage 44 (44a and 44b) are communicated with oil pan 46.

First oil pressure passage 41 includes: a first passage portion 41a formed at a position crossing over from the inside of cylinder head 22 to the central inside of camshaft 2; a first oil passage 41b which is formed to pass through the central inside of fixing bolt 26 in an axial direction so as to be branched in a head portion 26a and is communicated with first passage portion 41a; an oil chamber 41c which is formed between a small diameter outer peripheral face of head portion 26a and an inner peripheral face of bolt insertion hole 27a of base 27 of rotation member 3 to be communicated with first oil passage 41b; and four branching passages 41d which are formed to be substantially radially extended in base 27 of rotation member 3 and to be communicated with oil chamber 41c and respective advance angle side hydraulic chambers 32.

On the other hand, second oil pressure passage 42 includes: a second passage portion 42a formed at a position crossing over from the inside of cylinder head 22 to one side of the inside of camshaft 2; a second oil passage 42b which is formed to be extended in substantially L-shape inside sleeve 25 so as to be communicated with second oil passage portion 42a; four oil passage grooves 42c which are formed in outer peripheral hole edges of fitting hole 11 of rotation member 3, to be communicated with second oil passage 42b; and four oil galleries 42d which are formed in rear cover 8 at positions circumferentially spaced apart from each other approximately 90° to provide fluid communication between respective oil passage grooves 42c and retarded angle side hydraulic chambers 33.

In solenoid type switching valve 45, an internal spool valve body thereof is arranged so as to relatively control the switching between respective oil pressure passages 41 and 42, and supply passage 43 and drain passages 44a and 44b. Also, the switching of solenoid type switching valve 45 is operated based on a control signal from an engine control unit 48.

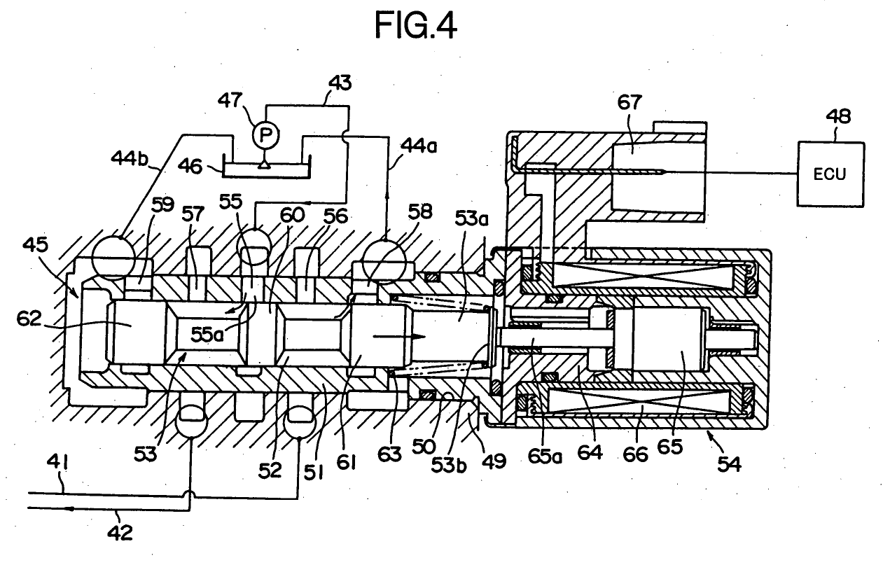

To be specific, as shown in FIG. 4 to FIG. 6, solenoid type switching valve 45 includes: a cylindrical valve body 51 inserted to be fixed into a retaining hole 50 of a cylinder block 49; a spool valve body 53 which is slidably disposed to a valve hole 52 in valve body 51 to switch fluid passages; and a proportional solenoid type electromagnetic actuator 54 for operating spool valve body 53.

A supply port 55 for providing a fluid communication between the downstream end of supply passage 43 and valve hole 52 is formed to pierce through a peripheral wall of valve body 51 at a substantially center position thereof, and also, a first port 56 and a second port 57 for providing communication between the other end portions of first and second oil pressure passages 41 and 42 and valve hole 52 are formed also to pierce through valve body 51 at positions on both side of supply port 55.

Further, third and fourth ports 58 and 59 for providing communication between both drain passages 44a and 44b and valve hole 52 are formed to pierce through both end portions of the peripheral wall of valve body 51.

Spool valve body 53 includes a substantially cylindrical first valve portion 60 for opening/closing supply port 55 at the center of small diameter shaft portion thereof, and also includes substantially cylindrical second and third valve portions 61 and 62 for opening/closing third and fourth ports 58 and 59 at both end portions of small diameter shaft portion thereof.

Further, spool valve body 53 is urged toward the right side direction in the figures, namely, in the direction for fluidly communicating supply port 55 with second oil pressure passage 42 in first valve portion 60, by a conical valve spring 63 elastically interposed between an umbrella portion 53b disposed on one edge of a front end side spindle 53a and a spring sheet 51a that is disposed on a front end side inner peripheral wall of valve hole 52.

Electromagnetic actuator 54 includes a core 64, a movable plunger 65, an excitation coil 66, a connector 67 and the like, and a driving rod 65a for pressing umbrella portion 53b of spool valve body 53 is fixed to the tip end of movable plunger 65.

Engine control unit 48 detects current operating conditions (an engine load, an engine rotation speed and the like) based on signals from a rotation sensor 101 for detecting the engine rotation speed and an air flow meter 102 for detecting an intake air amount of the engine. Further, engine control unit 48 detects a relative rotational position between cam sprocket 1 and camshaft 2, that is, a rotational phase of camshaft 2 with respect to the crankshaft, based on signals from a crank angle sensor 103 and a cam sensor 104.

Engine control unit 48 controls a quantity of power supply to electromagnetic actuator 54 based on a duty control signal.

For example, when a control signal of duty ratio 0% (OFF signal) is output to electromagnetic actuator 54 from engine control unit 48, spool valve body 53 is moved by the spring force of valve spring 63 to a position shown in FIG. 4, that is, to the axially maximum position in the right hand direction.

Thus, first valve portion 60 opens an opening end 55a of supply port 55, to fluidly communicate supply port 55 with second port 57, and at the same time, second valve portion 61 opens an opening end of third port 58 while permitting fourth valve portion 62 to close fourth port 59.

Therefore, the hydraulic fluid pumped from oil pump 47 is supplied to retarded angle side hydraulic chambers 33, through supply port 55, valve hole 52, second port 57, and second oil pressure passage 42, and further, the hydraulic fluid in advance angle side chambers 32 is discharged into oil pan 46 from first drain passage 44a through first oil passage 41, first port 56, valve hole 52 and third port 58.

Consequently, an inner pressure of retarded angle side hydraulic chambers 33 becomes a high pressure while an inner pressure of advance angle side hydraulic chambers 32 becomes a low pressure, and rotation member 3 is rotated in one direction to the maximum extent by means of vanes 28a to 28d.

As a result, cam sprocket 1 and camshaft 2 perform a relative rotation in one circumferential side so that the phase is changed to the retarded angle side, so that a valve opening period of the intake valve is delayed, and the overlap of the intake valve with an exhaust valve becomes small.

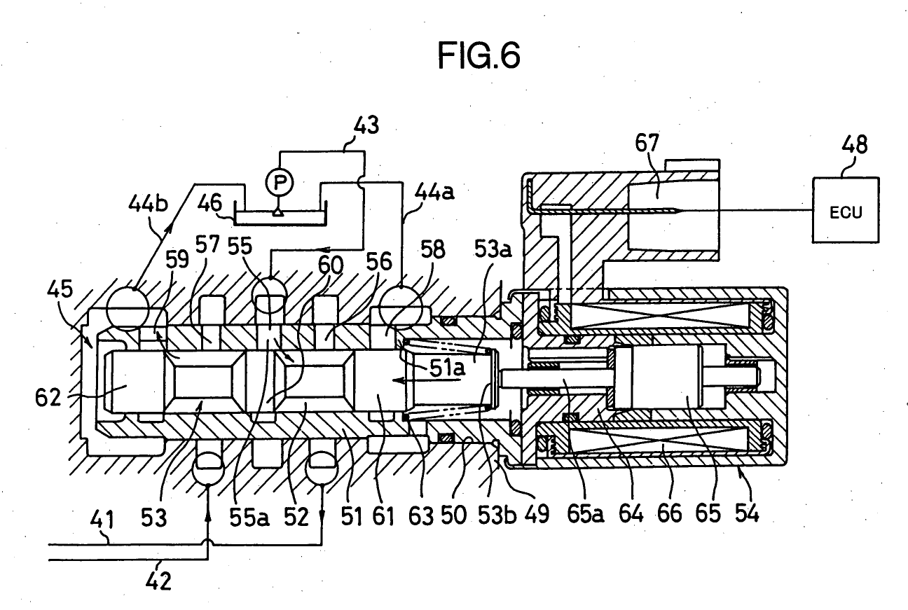

On the other hand, when a control signal of duty ratio 100% (ON signal) is output to electromagnetic actuator 54 from engine control unit 48, spool valve body 53 is slid to the extreme position in the left hand direction as shown in FIG. 6, against the spring force of valve spring 63. As a result, third valve portion 61 closes third port 58, and at the same time, fourth valve portion 62 opens fourth port 59, and also, first valve portion 60 provides a fluid communication between supply port 55 and first port 56.

Therefore, the hydraulic fluid is supplied to advance angle side hydraulic chambers 32 through supply port 55, first port 56 and first oil pressure passage 41, and also, the hydraulic fluid in retarded angle side hydraulic chambers 33 flows through second oil pressure passage 42, second port 57, fourth port 59 and second drain passage 44b, to be discharged into oil pan 46, so that the inner pressure of retarded angle side hydraulic chambers 33 becomes lower.

Consequently, rotation member 3 is rotated in the other direction by means of vanes 28a through 28d. Thus, cam sprocket 1 and camshaft 2 perform a relative rotation to the other circumferential side, and the phase is changed to the advance angle side. As a result, the opening period of the intake valve is advanced and the overlap of the intake valve with the exhaust valve becomes large.

Engine control unit 48 sets a duty ratio at which first valve portion 60 closes supply port 55 and third valve portion 61 closes third port 58 and fourth valve portion 62 closes fourth port 59, as a base duty ratio BASEDTY, while setting a feedback correction component UDTY for obtaining conformity of the rotational phases between cam sprocket 1 and camshaft 2, which is detected based on the signals from crank angle sensor 103 and cam sensor 104, to a target value (target advance value) of the rotation phase, which is set according to the operating conditions.

Then, engine control unit 48 sets the addition result of the base duty ratio BASEDTY and the feedback correction component UDTY as a final duty ratio VTCDTY, to output a control signal of the duty ratio VTCDTY to electromagnetic actuator 54.

Note, the base duty ratio BASEDTY is set at a substantially middle value (for example, 50%) in a duty ratio range where supply port 55, third port 58 and fourth port 59 are all closed and accordingly, the oil supply/discharge is not performed to/from any hydraulic chambers 32 or 33.

Namely, in the case where the rotation phase needs to be changed to the retarded angle side, the duty ratio is decreased with the feedback correction component UDTY, so that the hydraulic fluid pumped from oil pump 47 is supplied to retarded angle side hydraulic chambers 33, and also, the hydraulic fluid in advance angle side hydraulic chambers 32 is discharged into oil pan 46.

Contrary to the above, in the case where the rotation phase needs to be changed to the advance angle side, the duty ratio is increased with the feedback correction component UDTY, so that the hydraulic fluid is supplied to advance angle side hydraulic chambers 32, and also the hydraulic fluid in retarded angle side hydraulic chambers 33 is discharged into oil pan 46.

Then, in the case where the rotation phase needs to be held in the current status, the control is performed such that an absolute value of the feedback correction component UDTY is decreased so that the duty ratio returns to a duty ratio in the vicinity of the base duty ratio, and also, the control is performed such that supply port 55, third port 58 and fourth port 59 are all closed (the stop of supply/discharge of the oil pressure) so that the inner pressures of respective hydraulic chambers 32 and 33 are held unchanged.

Engine control unit 48 has a function of feedback-controlling the duty ratio of the duty control signal output to electromagnetic actuator 54 by a proportional-plus-integral-plus-derivative action based on the deviation between the target advance value and an actual advance value so that the target advance value according to the engine operating conditions is achieved as described in the above, and also has a function of diagnosing a response delay in variable valve timing apparatus 109.

The diagnosis of response delay is performed based on, for example, a period of time required for the actual advance value to be converged in the target advance value after the target advance value is changed in stepwise, the duration during which the deviation between the target advance value and the actual advance value is equal to or larger than a predetermined value, a changing speed of the actual advance value immediately after the target advance value has been changed in stepwise, and the like.

In the case where an occurrence of response delay is judged as the response delay diagnosis result, this response delay is warned to a vehicle user as the failure of variable valve timing apparatus 109.

If the response diagnosis is not normally functioned, although the response delay in variable valve timing apparatus 109 occurs, the measures, such as the warning to the user and the like, cannot be executed.

Therefore, in the present embodiment, as described later, the evaluation is performed as to whether or not the response diagnosis is normally functioned.

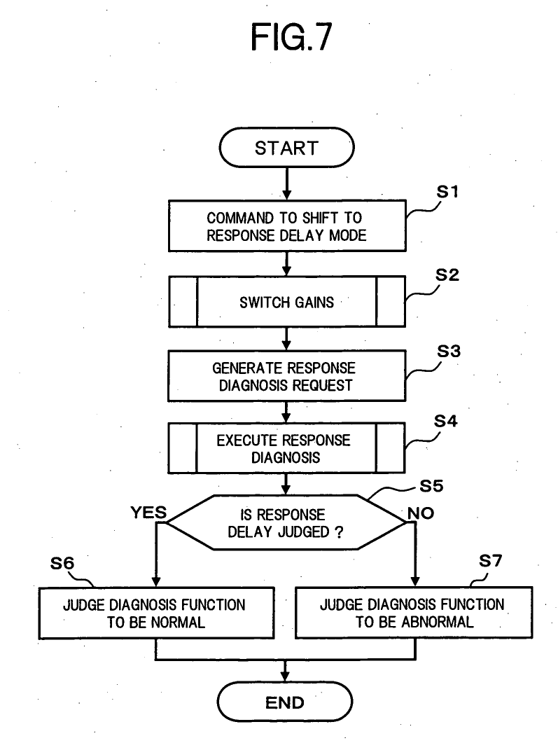

In the case where the evaluation of response diagnosis function is performed, an external tester 110 is connected to engine control unit 48 so that the evaluation of diagnosis function is executed as shown in a flowchart of FIG. 7.

In the flowchart of FIG. 7, firstly, in step S1, external tester 110 sends engine control unit 48 a command to shift to a mode for degrading, in a forcible manner, the response of variable valve timing apparatus 109.

Engine control unit 48 received the command executes the switching of feedback gains in step S2.

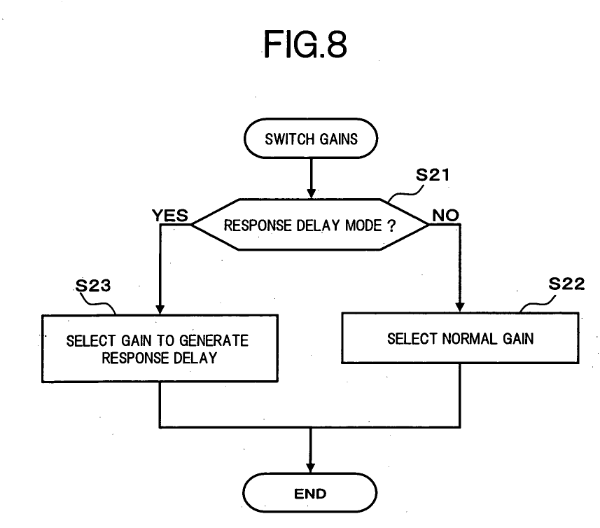

The switching processing of gains in engine control unit 48 is shown in a flowchart of FIG. 8.

In step S21, it is judged whether or not the shift to the mode for degrading the response in a forcible manner is commanded.

Then, in the case where the command is not sent, control proceeds to step S22, where a normal value is selected as the feedback gain, whereas in the case where the command is sent, control proceeds to step S23, where a value by which a response characteristic is degraded compared with the normal value is selected as the feedback gain.

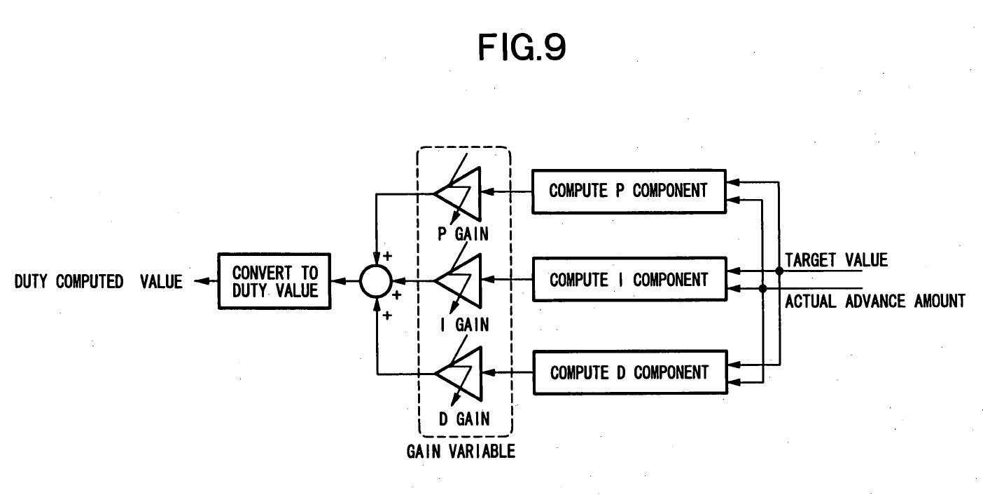

As shown in FIG. 9, in engine control unit 48, a proportional component P, an integral component I and a derivative component D are respectively computed based on the deviation between the target advance value and the actual advance value in variable valve timing apparatus 109, and the sum thereof is output as the feedback correction component UDTY.

Here, as each of a proportional gain, an integral gain and a derivative gain to be used for the computation of the proportional component P, the integral component I and the derivative component D, two types of values, namely, a normal value and a value for forcibly generating the response delay, are switched to each other. In the case where a signal for commanding the shift to the mode for degrading the response in a forcible manner is output from external tester 110, the switching is made from the normal gain to the gain for the forcible generation of the response delay.

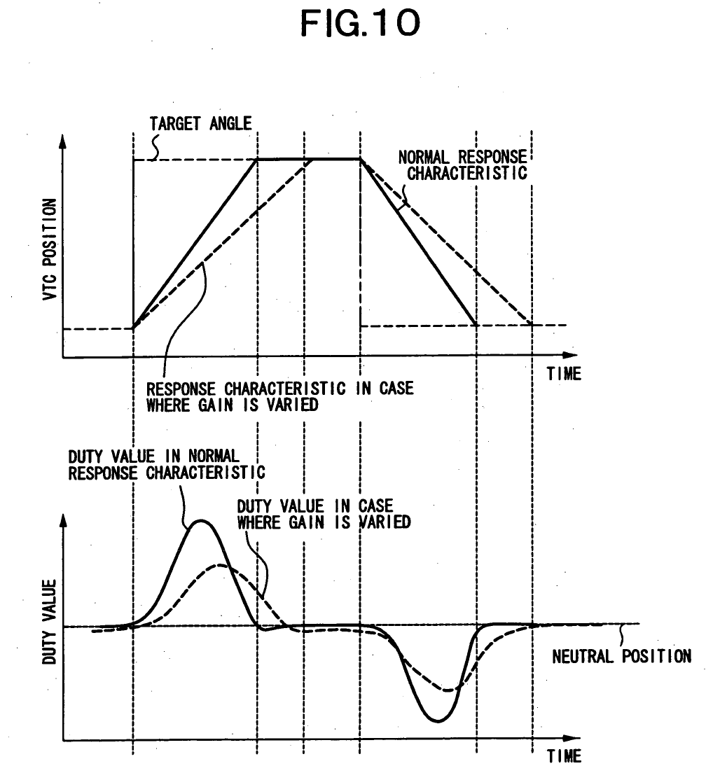

If the proportional gain and the integral gain are made smaller than the normal values for example, a change in the feedback duty with respect to the deviation is limited to be smaller, and as a result, the response to approach the target advance value is degraded (refer to FIG. 10).

The gain selected in the mode for degrading the response in a forcible manner is set at a value by which occurrence of response delay is diagnosed in the response diagnosis even if other hardware and the like are normally operated, in the case where the feedback control is performed with this gain.

External tester 110 outputs a response diagnosis execution request signal to engine control unit 48 in step S3, after commanding the shift to the mode for degrading the response in a forcible manner.

Engine control unit 48 received the response diagnosis execution request signal executes the response diagnosis in step S4.

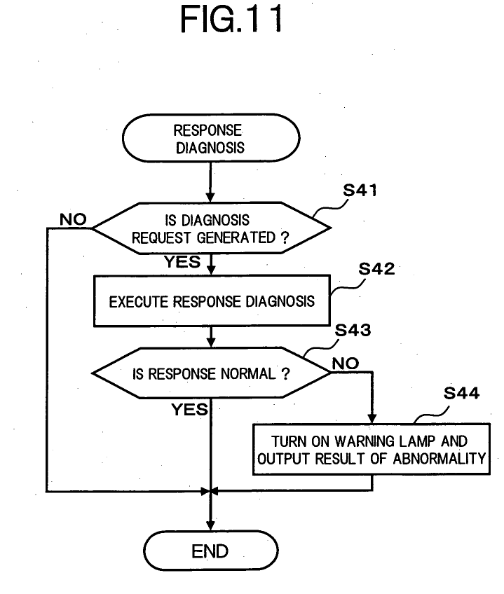

The details of the response diagnosis executed in step S4 is shown in a flowchart of FIG. 11.

In step S41, it is judged whether or not the response diagnosis request is output, and when it is judged that the response diagnosis request is output, control proceeds to step S42.

In step S42, it is diagnosed whether or not the response of variable valve timing apparatus 109 is deteriorated, based on the period of time required for the actual advance value to converge in the target advance value, the duration during which the deviation between the target advance value and the actual advance value is equal to or larger than the predetermined value, the changing speed of the actual advance value immediately after the target advance value has been changed in stepwise, and the like.

In step S43, as the response diagnosis result, it is judged whether or not it is judged that the response of variable valve timing apparatus 109 is normal.

Then, in the case where it is judged that the response characteristic is deteriorated, control proceeds to step S44, where a warning lamp for warning the failure of variable valve timing apparatus 109 is turned on, the diagnosis result of response deterioration is output and so on.

After the response diagnosis as described above is executed, in step S5 in the flowchart of FIG. 7, it is judged whether or not the response deterioration in variable valve timing apparatus 109 is diagnosed.

Since the feedback gain has been switched to deteriorate, in a forcible manner, the response in step S2, if the response diagnosis function is normal, the deterioration of the response should be diagnosed.

Accordingly, in the case where it is judged that the response is normal, the result of an erroneous diagnosis indicating that the response is normal is indicated, even though the response is deteriorated. Thus, it is able to judge the abnormality of diagnosis function.

Therefore, in the case where the response deterioration is diagnosed in step S4, control proceeds from step S5 to step S6, where it is evaluated that the response diagnosis is normally functioned, and this evaluation is output.

The output of evaluation result is performed as the character display of “diagnosis function OK” on a screen 110a provided for external tester 110.

On the other hand, in the case where the response deterioration is not diagnosed in step S4, since it is judged that the response is normal as the diagnosis result, although the response delay actually occurs as the result of switching the feedback gains, control proceeds from step S5 to step S7, where it is evaluated that the diagnosis function is abnormal, and this evaluation is output.

As a result, the abnormality of diagnosis function is detected and the restoration of diagnosis function can be achieved. Therefore, it is possible to improve the reliability of diagnosis function.

In the above description, the constitution is such that the transient response of variable valve timing apparatus 109 is degraded in a forcible manner by switching the feedback gains. However, the constitution may be such that, by limiting the range of the duty ratio VTCDTY of the control signal output to electromagnetic actuator 54 to be narrower than a normal range, the transient response is degraded in a forcible manner.

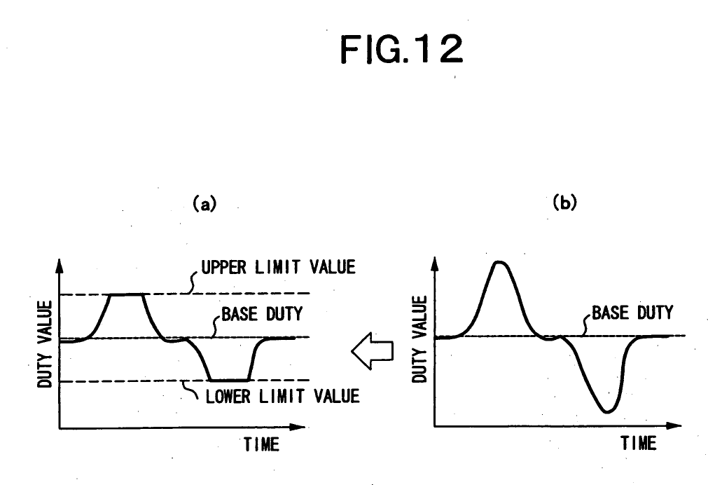

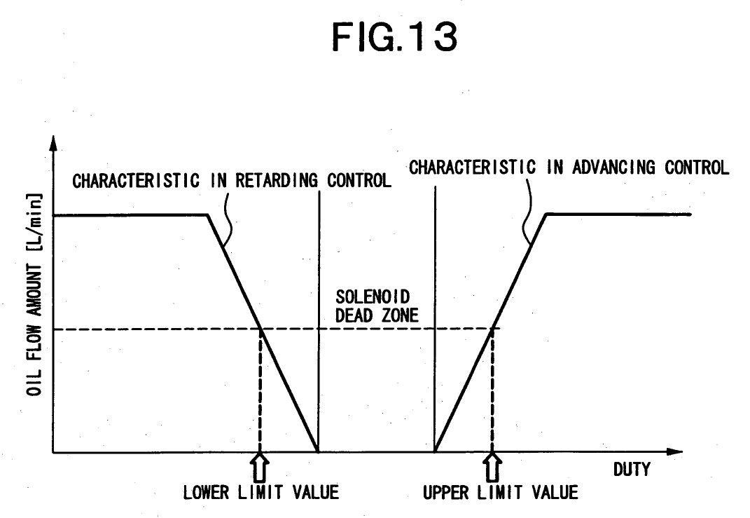

For example, the duty ratio VTCDTY is generally changed in a range of 0 to 100%. However, as shown in FIG. 12, if the range of the duty ratio VTCDTY is reduced to 30% to 70% or 40% to 60%, an oil flow amount supplied to the hydraulic chambers via the spool valve is decreased, and the oil flow amount drained from the hydraulic chambers via the spool valve is decreased (refer to FIG. 13).

Consequently, the response in variable valve timing apparatus 109 is delayed in both of the advance angle side and the retarded angle side.

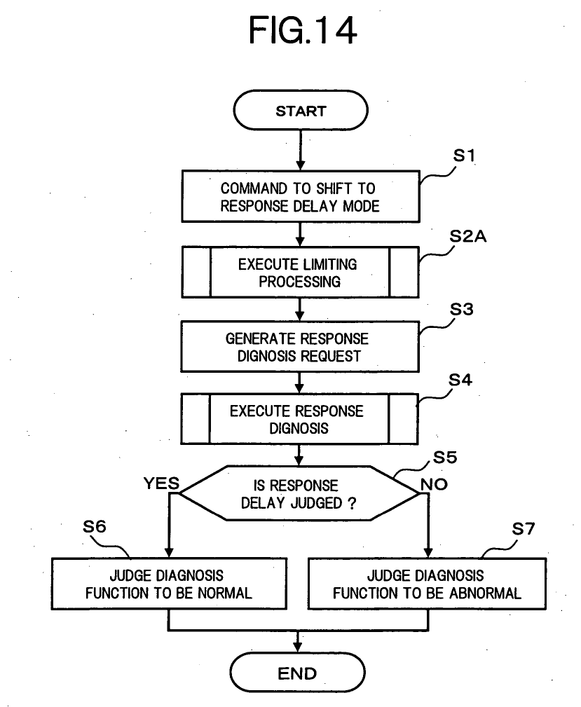

A flow chart in FIG. 14 shows an embodiment in which the response diagnosis function is evaluated by forcibly generating the response delay by limiting the duty ratio VTCDTY.

The flowchart in FIG. 14 differs from the flowchart in FIG. 7 only in the processing of step 2A.

In step S2A, the limiting processing for limiting the duty ratio VTCDTY into the range narrower than the normal range is executed.

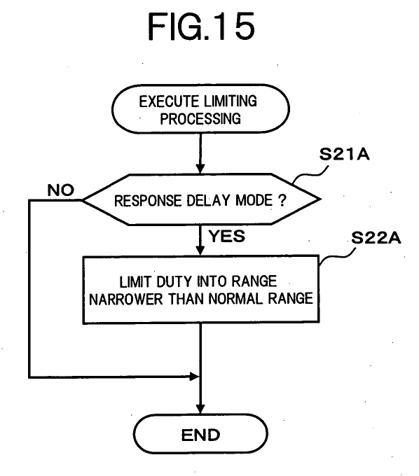

To be specific, as shown in a flowchart of FIG. 15, in step S21A, it is judged whether or not the shift to the mode for degrading the response in a forcible manner is commanded.

Then, in the case where the command is not made, the present control routine is terminated as it is, so that the duty ratio VTCDTY is changed within the range of 0 to 100%. In the case where the command is made, control proceeds to step S22A, where the limiting processing for limiting the duty ratio VTCDTY into the range (for example, 30% to 70% or 40% to 60%) narrower than the normal range is executed.

As described in the above, the limiting processing for limiting the duty ratio VTCDTY into the range narrower than the normal range is executed, so that the response of variable valve timing apparatus 109 is forcibly delayed. Therefore, similarly to the case where the feedback gains are switched, in the case where the response delay is not diagnosed under the state where the response is forcibly delayed, it is estimated that the response diagnosis function is abnormal.

Note, the variable valve mechanism is not limited to the above described hydraulic variable valve timing mechanism 109, and may be a variable valve timing apparatus having a constitution in which the rotational phase of the camshaft with respect to the crankshaft is changed with the frictional braking of an electromagnetic clutch (electromagnetic brake), which is disclosed in Japanese Unexamined Patent Publication No. 2001-164951 or Japanese Unexamined Patent Publication H10-153104, or may be a variable valve mechanism for rotating a control shaft by a motor to continuously vary a valve lift amount of an engine valve together with an operating angle thereof, which is disclosed in Japanese Unexamined Patent Publication No. 2001-012262. Further, the control signal is not limited to the duty signal.

Further, in the case where only the response of the operating characteristic to a given one direction is deteriorated by limiting the changing range of the control signal of the variable valve mechanism, it is possible to evaluate the response diagnosis function based on the judgment as to whether or not the response deterioration is diagnosed in such a given one direction.

Moreover, the feedback control of the variable valve mechanism is not limited to the proportional-plus-integral-plus-derivative action, and may be performed by a proportional-plus-integral control, a sliding mode control or the like.

Furthermore, the constitution may be such that, without using external tester 110, engine control unit 48 evaluates the diagnosis response, and further, evaluates the diagnosis function at appropriate timing in the operating state by the user.

The entire contents of Japanese Patent Application No. 2004-325034 on Nov. 9, 2004, a priority of which is claimed, are incorporated herein by reference.

While only selected embodiments have been chosen to illustrate the present invention, it will be apparent to those skilled in the art from this disclosure that various changes and modifications may be made herein without departing from the scope of the invention as defined in the appended claims.

Furthermore, the foregoing description of the embodiments according to the present invention is provided for illustration only, and not for the purpose of limiting the invention as defined in the appended claims and their equivalents.

We claim:

1. A method of evaluating a diagnosis function to diagnose a transient response of a variable valve mechanism that varies an operating characteristic of an engine valve, comprising the steps of:
degrading the transient response of said variable valve mechanism in a forcible manner;
diagnosing the transient response of said variable valve mechanism under a state where the transient response is degraded in a forcible manner; and
evaluating the diagnosis function of the transient response based on a result of diagnosing of the transient response.

2. The method according to claim 1, wherein said step of degrading the transient response in forcible manner comprises the step of;
varying a manipulated variable of said variable valve mechanism to degrade the transient response.

3. The method according to claim 1, wherein said step of degrading the transient response in a forcible manner comprises the step of;
varying gains in a feedback control of said variable valve mechanism.

4. The method according to claim 3, wherein said step of varying the gains comprises the step of;
varying at least one of a proportional gain, an integral gain and a derivative gain in the feedback control of said variable valve mechanism.

5. The method according to claim 1, wherein said step of diagnosing the transient response comprises the steps of:
detecting the operating characteristic of said engine valve;
feedback-controlling said variable valve mechanism so that the operating characteristic of said engine valve reaches a target operating characteristic; and
diagnosing the transient response of said variable valve mechanism based on a detected value of the operating characteristic of said engine valve and said target operating characteristic.

6. The method according to claim 5, wherein said step of diagnosing the transient response of said variable valve mechanism based on the detected value of the operating characteristic of said engine valve and the target operating characteristic comprises the steps of:
measuring a period of time required for the detected value of the operating characteristic of said engine value to converge in said target operating characteristic; and
diagnosing the transient response of said variable valve mechanism based on said period of time.

7. The method according to claim 5, wherein said step of diagnosing the transient response of said variable valve mechanism based on the detected value of the operating characteristic of said engine valve and said target operating characteristic comprises the steps of:
computing a deviation between said target operating characteristic and the detected value of the operating characteristic;
measuring a duration during which said deviation is equal to or larger than a predetermined value; and
diagnosing the transient response of said variable valve mechanism based on said duration.

8. The method according to claim 5, wherein said variable valve mechanism is a mechanism for varying a phase of a camshaft with respect to a crankshaft, and wherein
said step of detecting the operating characteristic of said engine valve detects an advance value of said phase;
said step of performing the feedback control feedback-controls said variable valve mechanism so that the advance value of said phase reaches a target advance value; and
said step of diagnosing the transient response diagnoses the transient response of said variable valve mechanism based on a detected value of said advance value and said target advance value.

9. The method according to claim 1, wherein said step of degrading the transient response in a forcible manner comprises the step of;
limiting a range of manipulated variable of said variable valve mechanism to be narrower than a normal range.

10. The method according to claim 1, wherein said step of evaluating the diagnosis function of the transient response comprises the step of;
judging that the diagnosis function of the transient response is abnormal when it is diagnosed that the transient response is normal.

11. The method according to claim 1, wherein said step of degrading the transient response of said variable valve mechanism in a forcible manner comprises the steps of:
connecting an external tester to a control apparatus for controlling said variable valve mechanism;
receiving a command for response delay from said external tester by said control apparatus; and
degrading the transient response of said variable valve mechanism in a forcible manner by said control apparatus.

12. The method according to claim 1, wherein said step of diagnosing the transient response of said variable valve mechanism comprises the steps of:
diagnosing the transient response of said variable valve mechanism under the state where the transient response is degraded in a forcible manner; and
outputting a diagnosis result of the transient response to an external tester.

13. The method according to claim 1, wherein said step of evaluating the diagnosis function of the transient response is executed by a control apparatus that controls said variable valve mechanism.

14. A diagnosis apparatus for diagnosing a transient response of a variable valve mechanism which varies an operating characteristic of an engine valve, comprising:
a response delay generating section that degrades the transient response of said variable valve mechanism in a forcible manner;
a diagnosing section that diagnoses the transient response of said variable valve mechanism under a state where said response delay generating section is being operated; and
an evaluating section that evaluates the diagnosis function of said diagnosis section based on a diagnosis result of said diagnosis section.

15. The apparatus according to claim 14, wherein said response delay generating section varies a manipulated variable of said variable valve mechanism.

16. The apparatus according to claim 14, wherein said response delay generating section varies a gain of a feedback control during feedback-controlling of said variable valve mechanism.

17. The apparatus according to claim 16, wherein said response delay generating section varies at least one of a proportional gain, an integral gain and a derivative gain in the feedback control of said variable valve mechanism.

18. The apparatus according to claim 14, wherein said diagnosis section diagnoses the transient response of said variable valve mechanism based on an actual operating characteristic of said engine valve and a target operating characteristic thereof.

19. The apparatus according to claim 18, wherein said diagnosis section diagnoses the transient response based on a period of time required for the actual operating characteristic to converge in said target operating characteristic in the case where said variable valve mechanism is feedback-controlled so as to achieve said target operating characteristic.

20. The apparatus according to claim 18, wherein said diagnosis section comprises:
a deviation computing section that computes the deviation between said target operating characteristic and the actual operating characteristic;
a measuring section that measures the duration at which said deviation is equal to or larger than a predetermined value; and
a convergence delay diagnosis section that diagnoses the transient response based on a measurement result by said measuring section.

21. The apparatus according to claim 18, wherein said variable valve mechanism is a mechanism for varying a phase of a camshaft with respect to a crankshaft; and said diagnosis section diagnoses the transient response of said variable valve mechanism based on a target advance value and an actual advance value of said phase.

22. The apparatus according to claim 14, wherein said response delay generating section limits a range of manipulated variable of said variable valve mechanism to be narrower than a normal range.

23. The apparatus according to claim 14, wherein said evaluating section judges that the diagnosis function of said diagnosis section is abnormal in the case where said diagnosis section judges that the transient response of said variable valve mechanism is normal.

24. The apparatus according to claim 14, wherein said response delay generating section is provided for a control apparatus that controls said variable valve mechanism; and said response delay generating section, when receiving a command from an external tester connected to said control apparatus, degrades the transient response of said variable valve mechanism in a forcible manner.

25. The apparatus according to claim 14, wherein said diagnosis section is provided for a control apparatus that controls said variable valve mechanism.

26. The apparatus according to claim 14, wherein said evaluating section is provided for an external tester connected to a control apparatus that controls said variable valve mechanism.

27. The apparatus according to claim 14, wherein a control apparatus for controlling said variable valve mechanism is internally provided for a control apparatus that controls an internal combustion engine.

28. The apparatus according to claim 14, wherein said diagnosis section is provided for a control apparatus that controls said variable valve mechanism; and
said control apparatus is provided with an output section that outputs the diagnosis result by said diagnosis section to an external tester.

29. The apparatus according to claim 14, wherein said evaluating section is provided for a control apparatus that controls said variable valve mechanism; and
said control apparatus is provided with an output section that outputs an evaluation result by said evaluating section.
